(19) United States
(12) Patent Application Publication
(10) Pub. No.: US 2024/0370572 A1
(43) Pub. Date: Nov. 7, 2024

(54) ADVERSARIAL ATTACKS ON PERCEPTION COMPONENTS

(71) Applicant: Five AI Limited, Cambridge (GB)

(72) Inventors: Nicholas A Lord, Cambridge (GB); Luca Bertinetto, Cambridge (GB); Romain Mueller, Cambridge (GB)

(73) Assignee: Five AI Limited, Cambridge, OT (GB)

(21) Appl. No.: 18/562,133

(22) PCT Filed: May 19, 2022
(86) PCT No.: PCT/EP2022/063659

§ 371 Date: Nov. 17, 2023

(30) Foreign Application Priority Data
May 20, 2021 (GB) 2107255.8
May 27, 2021 (GB) 2107611.2

(51) Int. Cl. G06F 21/57

(52) U.S. Cl. CPC G06F 21/577; G06F 2221/034

(57) ABSTRACT

A computer-implemented method of generating black-box adversarial inputs to a perception component comprises computing an adversarial input by applying a perturbation to an original input, the adversarial input satisfying an attack objective when inputted to the perception component. The perturbation is determined by selectively combining component perturbations selected from a predetermined set of component perturbations. Inputs correspond to respective points in an input vector space, and the component perturbations encode principal attack directions in the input vector space for satisfying said attack objective, the principal attack directions having been determined by analyzing: (i) a set of sample attack directions, or (ii) a set of input samples.

### TECHNICAL FIELD

The present disclosure pertains to adversarial attacks performed on perception components, and to “black-box” adversarial attacks in particular.

### BACKGROUND

A perception component refers generally to a component that is capable of perceiving physical structure captured in an input. One example of a perception component is a suitably trained convolutional neural network. In computer vision applications, such inputs may take the form of conventional images. However, the techniques described herein can also be applied to other forms of input (such as point clouds, voxel tensors, surface meshes, or any other input in which perceivable physical structure is captured etc.). Such inputs may capture physical structure in two or three spatial dimensions. Perception includes computer vision but also other perception modalities such as radar, lidar etc.

An “attack” on a perception component means finding some “small” perturbation to an input that “fools” the perception component. Typically, this means a change that would not be readily perceptible to a human. For example, in the case of a perception component that classifies inputs in relation to predefined classes, finding a small perturbation that causes the perturbed input to be mis-classified would amount to a successful attack. Such attacks are a useful analytical tool, allowing problems with perception components to be identified and mitigated (e.g. through re-training, re-architecting or otherwise reconfiguring the perception component). As another example, a successful attack on an object detector might involve a perturbation to the input that causes a “missed” detection (false negative) or a false positive detection.

### SUMMARY

Score-based black-box adversarial attack methods have become increasingly effective. Methods based on numerical coordinate descent have struck a good balance in achieving high attack success rates with low perturbation norms and query counts, while being simple to conceive and implement. However, the choice of basis defining search directions has remained a relatively unexplored aspect of this class of approach.

An improved adversarial black-box method is provided that introduces prior information via basis choice. In particular, the method yields improved query efficiency compared with existing black-box methods, without relying on complex or bespoke heuristics.

According to a first aspect of the present subject matter, a computer-implemented method of generating black-box adversarial inputs to a perception component comprises computing an adversarial input by applying a perturbation to an original input, the adversarial input satisfying an attack objective when inputted to the perception component. The perturbation is determined by selectively combining component perturbations selected from a predetermined set of component perturbations. Inputs correspond to respective points in an input vector space, and the component perturbations encode principal attack directions in the input vector space for satisfying said attack objective, the principal attack directions having been determined by analysing: (i) a set of sample attack directions, or (ii) a set of input samples.

The terms “principal attack direction”, “dominant attack direction” and “dominant perturbation direction” are used interchangeably herein. The attack objective could, for example, be to cause the perception component to mis-classify the input, or to cause a missed object detection (false negative) or false object detection (false positive) etc.

The sample attack directions are directions in the input vector space. An attack direction could, for example, be a direction along which a successful attack has been observed. However, an attack direction could also be a direction that has been determined to be promising (likely to lead to a successfully attack), without necessarily observing a successful attack. Promising attack directions can be determined using numerical or analytical methods, and examples of such methods are described later.

In this context, a “successful” attack direction implies that a perturbation applied in that direction was found to have resulted in a successful attack; that is, a perturbation that, when applied to some input, caused the attack objective to be satisfied. This could have been a previous successful attack on the same perception component, or a successful attack on a “proxy” perception component (e.g. having a reasonably similar architecture and training set). This may be referred to as a “black box” approach, as it does not require “white box” access to the perception component.

A “promising” attack direction implies that direction is a likely candidate for a successful attack, without necessarily verifying the existence of a successful attack. For example, with full “white box” access to the perception component or a proxy (surrogate) perception component, it may be possible to formulate the attack objective as an attack loss function, and take the gradient of the attack loss function with respect to the input as a sample attack direction (this assumes a sufficiently large perturbation in the direction of the gradient will satisfy the attack objective, without necessarily verifying if that is the case).

Simply using sample gradients at different inputs has been found to be highly effective. The different inputs may be chosen as real inputs (e.g. real images). Alternatively, the different inputs could be random locations in image/input space (that is, randomly generated inputs/images). Gradients are very important in constructing adversarial attacks, but it is not always necessary to verify that the given sample gradient yields any specific result on its own, nor is it necessarily to actually adjust a step length in that direction, or iterate, etc. (many of the techniques that would be applied to actually perform an attack can be omitted). For example, in one of the described embodiments, the gradients are assembled into a data matrix, which in turn is decomposed to extract the dominant attack directions. Synthetic inputs (that are statistically similar to real inputs) could also be used. Such input may be generated using sensor modelling techniques and the like.

Numerical methods could also be used to identify promising attack directions, without necessarily observing a successful attack. For example, a numerical method could be used to estimate the gradient of an attack loss (or at least the direction of that gradient) at different points in the input space, without requiring full white box access.

An “attack direction” may be encoded in a vector in the input space, and that vector may be normalized or non-normalized. The terms “attack direction” and “attack vector” are used interchangeably herein. Unless otherwise indicated, neither term necessarily implies a successful attack, and neither term necessarily implies normalization (or lack thereof)—an attack direction/vector can encode a successful attack, or simply a promising direction for an attack.

It may also be possible to estimate the dominant perturbation directions from real inputs directly (input samples), without analysing the perception component or a proxy component. For example, a principal component analysis (PCA) of the inputs could be performed in order to estimate the dominant attack directions.

For example, the (mean-subtracted) real input samples may be fed to a data matrix (leveraging the extent to which a trained perception component is simply capturing modes of variation that exist in the data itself). It is typically more powerful to use information that derives from the perception component (or its proxy) in some way (rather than just the data). Nevertheless the data can be useful on its own; the assumption in this case is that the analysis of the input samples directly will determine modes that are similar to those learned by the perception component in training.

In this case, the input samples are chosen as inputs that are similar (or assumed to be similar) to those used to train the perception component under attack.

In embodiments, said analysis may be a singular value decomposition (SVD) or other decomposition (e.g. matrix factorization) of (i) or (ii) above.

In the case of (i), a data matrix (D) may be constructed by “stacking” perturbation vectors that resulted in a successful attack, or by stacking the gradients of the attack loss function.

In the case of (ii), the data matrix D may be constructed by simply stacking the known inputs (in this case, the SVD is simply a PCA of the known inputs).

The SVD may be formulated as D=UΣV^{T}.

In an SVD analysis, the dominant attack directions may be encoded as principal direction vectors (the vector components of U in the case that samples are stacked in D as columns, and V in the case that the samples are stacked as rows). That is, the component perturbations may be principal direction directors computed via the singular value decomposition. The matrix U may be referred to as the principal direction matrix in this context.

The following description may refer to the inputs as “vector inputs”, and the perturbations as “perturbation vectors”. Conceptually, each input is interpreted as a point in the input vector space, and each perturbation is interpreted as a translation of that point. This does not necessarily imply that the inputs are represented as vectors at the data level (e.g. the inputs could take the form of images, points clouds, voxel tensors etc.). The following description refers to images by way of example, but it will be appreciated that the inputs can take other forms, such as those mentioned previously. An attack direction encapsulates a perturbation pattern to be applied to the input.

In the embodiments described below, images, sample attack directions, and/or principal directions (which are themselves “images” or, more generally inputs of a sort, in the above interpretation, albeit inputs that would generally be used to transform other inputs) are fed into and taken out of the relevant SVD matrices. Images and attack directions are “flattened” into a vector according to a fixed convention which orders the coordinates. That is, rather than treating the image as a grid, it is treated as a point in a high-dimensional Euclidean space. The SVD (or other form of analysis) finds principal directions in that space. The principal direction vectors obtained via the SVD (the vector components of U or V depending on the construction of the data matrix D—see above) can, in turn, be applied to the original images by transforming them back to the original image representation (e.g. an (R,C, 3) grid used for representing colour images). Then they can be directly added to a regular colour image. Looking at the whole structure, the U or V matrix, as applicable, (which is 2D) ends up reshaped into a 4D tensor: one dimension for each direction, one for the colour channel, one for the original image height, one for the original image width—thus providing the set of component perturbations that can be selectively combined.

Whilst SVD is considered herein, other forms of analysis or decomposition can be used. For example, when the goal is to find adversaries within an l-infinity bound (meaning, where the bound is on the maximal intensity change allowed at any pixel), a different analysis technique may be used (although the 1-infinity case can be addressed by simply projecting and/or clamping an SVD-derived solution).

The term ‘principal direction’ is used herein, and for the avoidance of doubt, it is noted that the terminology applies equally to dominant attack directions identified via an analysis other than SVD. The term principal direction is used in the description below in the context of SVD, but it is noted that the description applies equally to dominant attack directions identified via an analysis other than SVD.

In embodiments of the first aspect, the method may comprise selectively modifying the perturbation vector, by selectively adding or subtracting principal direction vectors of the principal direction matrix, until the successful attack condition is satisfied.

The perturbation vector may be zero initially.

With SVD, the principal direction vectors may be ordered by decreasing singular value, and the perturbation vector may be selectively modified by applying the following steps, starting with the first principal direction vector, until the successful attack condition is satisfied:
determining at least one modified perturbation vector, by adding or subtracting the principal direction vector to/from the perturbation vector,
determining whether the modified perturbation vector satisfies a promising attack condition, and if so repeating the steps for the next principal direction with the modified perturbation vector, and if not, discarding the modified perturbation vector, and repeating the steps for the steps for the next principal direction without modifying the perturbation vector. For example, the perturbation vector may be selectively modified by applying the following steps:
determining a first modified perturbation vector, by doing one of: adding the principal direction vector to the perturbation vector, and subtracting the principal direction vector from the perturbation vector,
determining whether the first modified perturbation vector satisfies a promising attack condition, and if so repeating the steps for the next principal direction with the first modified perturbation vector,
if not, discarding the first modified perturbation vector, and determining a second modified perturbation vector, by doing the other one of: adding the principal direction vector to the perturbation vector, and subtracting the principal direction vector from the perturbation vector,
determining whether the second modified perturbation vector satisfies the promising attack condition, and if so, repeating the steps for the next principal direction with the second modified perturbation vector,
if not, discarding the second modified perturbation vector, and repeating the steps for the next principal direction without modifying the perturbation vector.

The following operations may be performed to determine whether a modified perturbation vector satisfies the promising attack condition:
applying the modified perturbation vector to the original input vector, to compute a perturbed input vector,
providing the perturbed input vector to the perception component, to obtain at least one numerical output value,
in the case of the first principal direction vector, comparing the numerical output value with a corresponding numerical output value obtained for the original input, in order to determine whether the promising attack condition is satisfied,
in the case of each subsequent principal direction vector, comparing the numerical output value with the numerical output value obtained for the previous principal direction vector, in order to determine whether the promising attack condition is satisfied.

For example, the comparison may be performed to determine whether an attack loss has been increased or decreased relative to the original inputs, where the attack loss encodes the attack objective.

For example, each numerical output value may be a confidence score, and the promising attack condition may be satisfied if the numerical output value indicates decreased confidence of the perception component.

For example, the confidence score may pertain to a known class to which the original input belongs, and the promising attack condition may be satisfied if the numerical output value indicates decreased classification confidence with respect to the known class. This is an example of an “undirected” attack, where the aim is to cause any mis-classification of the input.

Alternatively, the confidence score may pertain to a specific other class, and the promising attack condition may be satisfied if the numerical output value indicates increased classification confidence with respect to the specific other class. This is an example of a “directed” attack, where the aim is to cause the perturbed input to be classified as belonging to that specific other class.

In SVD, principal directions are assigned an order by singular value. However, the same approach can be applied with any statistical analysis of decomposition that assigns a relative order to the component perturbations, with the component perturbations being selectively applied considered in the assigned order (reflecting the relative dominance of the principal attack directions).

The above are examples of attacks on a classification network. However, the present techniques can be applied to formulate attacks on other types of perception components. For example, if an object detector provides a confidence score for a bounding box or other object detection output, the attack could be formulated with respect to the detection confidence, with the aim of finding a perturbation that causes a false positive or false negative.

The method may comprise identifying and mitigating a problem with the perception component based on the adversarial input(s) that has been found.

For example, the perception component may be modified (e.g. through re-training, re-architecting or otherwise reconfiguring the perception component) so that the adversarial input no longer satisfies the attack objective (in other words, so that the perception component is no longer ‘fooled’ by the perturbed input).

Each input may, for example, comprise one of the following modalities of perception data, or any combination thereof: image data, liar data or radar data.

The perception component may be for use in a robotic system for perceiving physical structure in an environment in which the robot system is operating.

For example, the method may comprise incorporating the above-mentioned modified perception component in a robotic system.

Further aspects provide a computer system comprising one or more computers configured to implement the method of the first aspect or any embodiment thereof, and executable program instructions for programming a computer system to implement the same.

### BRIEF DESCRIPTION OF FIGURES

To aid understanding, example embodiments of the subject matter will now be described with reference to the following schematic figures, in which:

FIG. 1 shows a perturbation applied to an image represented in an input vector space of a perception component;

FIGS. 2, 3 and 4 show experimental results for an adversarial black-box attack algorithm described herein; and

FIG. 5 shows a functional block diagram of a computer system for implementing a two-phase black box analysis.

### DETAILED DESCRIPTION

Score-based black-box adversarial attack methods have become increasingly effective. Methods based on numerical coordinate descent have struck a good balance in achieving high attack success rates with low perturbation norms and query counts, while being simple to conceive and implement. However, the choice of basis defining the search directions has remained a relatively unexplored aspect of this class of approach. Drawing on past insights on the transferability of adversarial examples, the identification of adversarial subspaces, and the connection between adversarial examples and class-specific features, the described embodiments provide a simple and highly effective method for improving this class of black-box attacks by introducing prior information via the basis choice. If desired, the described techniques can be implemented using an existing algorithm without any direct modification to the existing algorithm (and only modifying the basis choice), and can flexibly accommodate different “shades of grey” in terms of the prior information available to the attacker.

Whilst images and networks are referred to in the following, the description applies equally to other forms of perception input and/or other forms of perception model or component.

In the present context, a “query” means providing an input to a perception component under attack, and processing the resulting output to determine whether or not the attack objective has been met, or at least whether the attack loss has changed in a manner indicative of a promising attack direction.

Example embodiments are described below. First, some further relevant context to the described embodiments is provided. A list of references referred to in the text is provided at the end of the description.

A core restriction of score-based black-box attacks (e.g. [7, 16, 1, 2]) versus white-box ones (e.g. [26, 6, 12, 22]) is in the inability of the former to directly query the analytical gradients of a network (or other perception model/component) under attack. Accordingly, the two threat models are also respectively referred to as “zeroth-order” and “first-order oracle” settings, based on the derivative information directly available to a client. The zeroth-order setting represents the realistic scenario of an attacker lacking access to the internals of a classification model (which may, for example, be hosted on a remote server), but being able to pass inputs to that model and receive classification scores in response. In seeking to leverage this information while providing an alternative to purely transfer-based black-box attacks ([27]), the authors of [7] and [3] both suggested numerical gradient estimation-based search frameworks. Because the cost of naïve numerical gradient approximation is linear in the dimension of the input space, a key issue in any such framework is the reduction of the query count while maintaining the quality of the estimate. These two methods, “ZOO” and “Gradient Estimation”, explored various approaches between them: coordinate descent, dimension reduction, attention, and crucially, the use of image-space bases reflecting priors on the directions most likely to represent dominant components of the gradient. Suggestions included the DCT basis and the principal components of the input data.

While influential, these works left room for improvement. ZOO chose to effectively implement a black-box version of the Carlini-Wagner ([6]) attack with ADAM optimisation, thus trading high result quality for an extremely high query count in spite of the savings made otherwise. Gradient Estimation opted instead for a simple iterative FGM/FGSM ([12]) optimisation which made the opposite compromise between speed and efficacy. Additionally, and importantly, while it used a reduced-dimension prior-driven gradient estimation, it did not adopt coordinate descent as in ZOO. This gave way to a line of work ([15, 36 16, 19, 20, 37, 33]) which explored ways to improve the fundamental approach by experimenting with different optimisation methods and priors. Strikingly, and perhaps surprisingly, one of the most successful efforts was SimBA ([14]), for “Simple Black-Box Attack”. Its name derives from the fact that it is an especially stripped-back form of coordinate descent: the greedy sequential assignment of signs to fixed-length steps a long basis directions. Despite the fact that it can expend no more than two queries (the forward and backward differences) per dimension by design, it achieves competitive results in terms of the attack success rate and norm statistics of the realised perturbations.

The described embodiments apply the SimBA algorithm but with prior information inserted into the SimBA framework via a basis matrix parameter, with minimal modification otherwise. In doing so, a dramatic improvement is demonstrated to be possible through a simple, formulaic way of representing transferred gradient/adversary sample information. Notably, condition this prior information is not conditioned on the input image, and relies instead on established observations regarding the transferability of adversaries between images. Despite the fact that the described approach avoids complex or bespoke heuristics, our results are competitive with those of more heavily engineered state-of-the-art methods.

Effectively, the improvement is down to a strategic change of image-space basis which specifies a set of directions and a prescribed order for searching them, based on transferable network sensitivity analysis. It may be referred to as a “prioritised adversarial subspace span”. A key feature of the described framework is its ability to flexibly accommodate prior information according to its availability as dictated by the threat model, including in the case that nothing more is available than previous black-box attacks from a more naïve version of the method. There is no requirement to build an explicit surrogate model, though one can be leveraged if desired. In general, the described approach caters for whichever “shade of grey” the attacker finds themselves faced with, providing a suggestion for collecting and decomposing samples that provide useful information to the method in each case.

Evidently, black-box methods are useful when full white-box access to the model is unavailable. Additionally, as discussed below, there may also be situations in which a black-box analysis is beneficial even if white-box is available. A ‘black-box method’ generally refers to a method not requiring white box access (but the terminology does not necessarily imply that white box access is unavailable).

Certain factors motivating the described approach will now be described.

Beyond the demonstration of vulnerability itself, the study of white-box adversarial attacks has yielded many insights into often unexpected properties of network decision boundaries, including ones that are shared across input points and network architectures. In the relatively early [12], the authors explicitly made (among others) the following three observations:
1. “The generalization of adversarial examples across different models can be explained as a result of . . . different models learning similar functions when trained to perform the same task.”
2. “The direction of perturbation, rather than the specific point in space, matters most.”
“Because it is the direction that matters most, adversarial perturbations generalize across different clean examples.”

One way of summarising these points is to say that there exist adversarial perturbations that are basically agnostic of the network and input on which they are applied. That is, [12] introduces the existence of the universal adversarial perturbations (UAPs) later explored in detail in [24]. But another way of phrasing the same observation is that there exists a strong and readily available prior on the attack that is likely to work at a given point: an attack that has already worked at a different point, including potentially on a different network. How strong a prior is this in reality, and how best should it be applied? To begin answering this, it is useful to examine another claim from the same reference: that adversarial examples “are a result of models being too linear, rather than too nonlinear.” This statement is open to some interpretation, and it is important to consider it further. If deep networks actually implemented linear functions, the question of finding an adversarial example at any point would be trivial. By the definition of linearity, the decision function gradient would be constant everywhere. In the white-box scenario, this constant gradient could be queried once, and would then directly yield the nearest point on the decision boundary from any sample in closed form, requiring only a single forward pass to compute the score at that sample. The score-based black-box scenario would differ little, beyond the use of a numerical method to initially determine the gradient instead. In other words, under this extreme assumption, a single successful attack would be the strongest possible prior: a full specification.

In reality, however, the situation is more complicated than this. It is true that local linear approximations do work very well across a variety of first-order attacks: the very effective DeepFool attack [26] is essentially the method described above: the analytic solution of the location of the nearest decision boundary point under the linear assumption. However, recognising that gradients are not constant over input space, the algorithm queries the gradient at each iteration to adjust for differences over starting points, as well as errors in the linear approximation at any given starting point. In fact, as explored in depth in [25] and [11], decision boundaries are typically curved in the vicinity of samples, and it is precisely the directions of high curvature that are of most interest in characterising network behaviour. There is no contradiction between classifier non-linearity and the existence of UAPs: [25] illustrates how the curved decision boundary model can be used to predict their existence. The key fact to note for present purposes is that while UAPs can (and, under some assumptions, must) exist in the curved-boundary framework of [25], they cannot be expected to be optimal at any given point: the perturbations of [24] are much larger than the image-specific perturbations of [26] from which they are formed. There is typically no single adversarial direction representing the maximally effective perturbation over all points: it has been known since at least [21] that gradients of the same adversarial objective at different points can be orthogonal to one another, and that there exists an “adversarial subspace” within which that perturbation must be identified at each sample. This subspace is often much lower-dimensional than the embedding space of the inputs, and its basis vectors thus communicate critical information.

All gradients, and thus, adversarial attacks, can be well approximated through linear combinations of these basis vectors. But for optimal (low-norm) attacks, the coefficients must be determined in an input-specific way: gradient transfer is real, but it involves subtleties. Why this is so is perhaps most easily understood through an intuition about what it is that these directions represent. Roughly speaking, they are class-identifying features¹. UAPs typically work by supplying a signal associated with a target class that overwhelms the evidence of the source class (whatever it may be), as demonstrated in [18]. [24], in seeking only to find effective UAPs, produced a connectivity diagram illustrating their tendency to target single classes despite the lack of any explicit incentive to do so in the algorithm². The authors of [29] were thus able to design a network specifically to produce class-targeting UAPs. Using this phenomenon as a starting point, the authors of [18] explained and demonstrated the fact that these “adversarial” directions simply represented the features used for classification generally, a fact that had long been implicitly understood in e.g. the interpretation of network gradients as “saliency maps” in [31]. This concept was later popularised by [17] under the phrasing “adversarial examples are not bugs, they are features”. The basis of an “adversarial subspace”, then, can be thought of as a bank of features, and the mutual orthogonality of those features represents the ability of a (non-linear) network to associate features with classes, including alternately associating multiple features with the same class. These features may maintain a consistent significance across examples and networks, but the nature of the combinations required to produce certain responses may depend to some extent on the input to which they are applied. ¹ The “adversarial vulnerability” is chosen because these features and/or their usage do not appear to correspond to the human understanding of class characterisation, even if they may be strongly correlated with class membership in many circumstances.² See FIG. 7 of that work for a graphical depiction.

Returning to the question posed above (regarding the nature of the prior and how to apply it), it would be desirable to transfer the feature bank spanning the adversarial subspace, whilst retaining freedom to tailor the combinations of these features to each specific image being attacked. That is, the basis vectors will be fixed, but their coefficients are to be determined online. In fact, this is precisely what SimBA does, with the key simplification that the coefficient magnitudes are fixed, with only the signs left to be determined Phrased another way: SimBA simply chooses signed combinations of features from a given bank based on their local adversarial effectiveness, accumulating them greedily as it goes. The issue is that in its original implementation, it does so only from the canonical pixel and DCT bases, which are not necessarily optimal, especially as it is unclear how best to order them a priori.

Motivated by the above considerations, in the described embodiments, a more optimal basis for SimBA, complete with ordered search priorities, is determined through the singular value decomposition (SVD) of a data matrix of adversarial perturbation samples. The source of these varies according to the specifics of the threat model: the method naturally accepts and leverages any relevant sample information available to it.

The described approach does not require dynamically maintaining or even forming a surrogate (though it is an option): in fact, the method involves no prior conditioning on the input point at all, at runtime. On the other hand, search directions are assigned a predefined order in the basis construction, rather than choosing them randomly online; the method also operates directly in that basis.

Example embodiments will now be described.

In the following examples, an attack is performed in two phases. In the first phase, attack priors are gathered, and an ordered basis for the second phase is derived from the attack priors. In the following examples, that analysis involves a singular value decomposition applied to the attack priors. The attack priors gathered in the first phase can take various forms. In the following examples, the attack priors are vectors in input space, which may represent promising or successful attack directions (interpreted as vector perturbations applied to points in the input space)—gathered using white box, black box or proxy methods—or real inputs (interpreted as points in the input space) from which the basis is inferred directly.

The SVD is formulated as D=UΣV^{T}, where D (the data matrix) contains the attack priors (vectors in the input space), and the principal directions of U or V provide the ordered basis, depending on whether the attack priors are stacked as columns or rows of D. The following examples refer to the attack priors being stacked as columns such that U provides the basis for the second stage, but it will be appreciated this in an arbitrary convention that does not carry any implications as to the physical or logical structuring of the data.

In the second phase, vectors are sampled and combined from the ordered basis, with the aim of achieving successful attacks on a given perception component. The ordered basis is a distillation of gradient information captured in the attack priors of the first phase, and guides the second phase to successful attacks with fewer queries to the perception component.

SVD assumes a Gaussian distribution of the underlying inputs. As will be appreciated, other analysis methods can be used to extract principal attack directions, based on different assumption(s) about the underlying data. The purpose of the analysis is to identify dominant directional modes within the underlying data D (encoded in the principal attack directions/basis).

As described in further detail below, there are various ways in which the source of the sample attacks can be determined to populate the initial data matrix D in the first phase. Depending on the information available to the attacker offline, the following sources may be considered (among others):
White-box analysis of the network under attack. This does not represent a common threat model, but may nevertheless be useful for analytical purposes (it also provides a reference bound for the other approaches).
Using a black-box method on the same network with an initial set of inputs, modifying Q for the subsequent inputs. Note that this can be SimBA or Mufasa itself, with a naive choice of Q such as the randomly ordered pixel or DCT basis. We refer to this as “recycling”.
Attacking a proxy network, using the original training data if available, else a proxy training set.

In scenarios in which white-box offline access is involved, network gradients with respect to input images may be used as the “attack” vectors, looking through the particulars of common white-box methods to the fact that they are essentially variants on gradient ascent.

### First Phase

Given input x, and a classification model that provides confidence scores p_{y′}(x) for each class y′∈Y, an attack can be formulated in terms of some perturbation z to the original input X:

$${p}_{{y}^{′}} ( x + z ; θ )$$

Here, Y is the set of classes over which the model is defined, and θ denotes the parameters of the model (omitted below for conciseness). This can be generalized to other types of score/model. For example, the attack could be formulated with respect to detection confidence score associated with object detection, where a successful attack results in a “missed” detection (e.g. confidence score below some detection threshold).

Here, y denotes the “correct” class label for x, e.g. the class label with the highest p_{y}(x) (the perception component's class prediction for the original, unperturbed input x).

A successful attack on the classification model can be described as perturbing the input x so as to “flip” the class label. That is to say, one attack objective might be to find z such that the perturbed input is mis-classified:

$${p}_{{y}^{′}} ( x + z ) > {p}_{y} ( x + z )$$

for either a specific y′≠y (targeted attack) or any y′≠y (untargeted attack).

More generally, an attack loss l(x) is defined so as to encode an attack objective. There are various ways of defining an attack loss l(x) to encode a given attack objective. Typically, the attack loss is defined on a single score produced by the perception component. For example, a classification perception component might output probabilities (normalized scores) across a set of perception classes Y (e.g. image classes); typically, the attack loss l(x) is formulated with respect to only one of those classes. However, in other implementations, an attack loss may be based on one or multiple scores.

In the following examples, the aim is to minimize the attack loss l(x) with respect to the input x. As will be appreciated, this can also be described as maximizing the attack loss −l(x). For a targeted attack om a classification component, the attack loss may, for example, be defined as

$${l}_{{y}^{′}} ( x ) = - {p}_{{y}^{′}} ( x )$$

such that the aim is to maximize the probability of the specific class y′ (or, equivalently, minimize the negative of that probability). For an untargeted attack, the attack loss may, for example, be defined as

$${l}_{y} ( x ) = {p}_{y} ( x )$$

such that the aim is to minimize the probability of the correct class y.

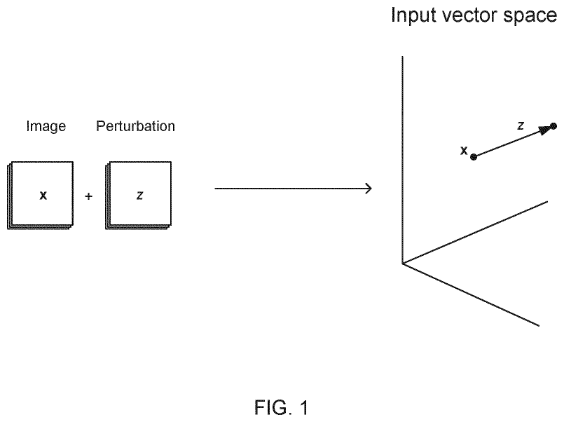

FIG. 1 shows how a perturbation to an image x may be characterized as a perturbation vector z in an input space of a perception model. Three dimensions are depicted but the input space can have any number of dimensions, including much higher dimensionality than three.

A spatial representation of x would typically be inputted to the model (perception component). For example, a W×H×D tensor where D (the depth/number of channels) is 3 for a colour image. However, within the attack framework, the input x is treated as a point in an input space of dimensionality N=WHD, and the perturbation z as a vector translation of the point x in the input space (see FIG. 1).

The above is a useful characterization, as the direction of an attack vector z towards an attack boundary in the input space has been found to be more useful in guiding future attacks than the magnitude of the attack vector z. For this reason, it is useful to express the attack vector z as:

$$s = ϵ \hat{δ} ,$$

where ε=∥z∥ (the magnitude of z) and \hat{δ} is a unit vector in the direction of z. The following description refers to δ, which is not necessarily normalized, with

$$\hat{δ} := \frac{δ}{‖ δ ‖} .$$

Note that the term “attack vector” may also be used in reference to the normalized direction \hat{δ}.

### White Box Attack

“White box” access to the perception component (or a proxy component) means that the gradient of the attack loss ∇ₓl(x) can be computed analytically with respect to input x, e.g. via backpropagation. Whilst superficially similar to training, the present application is quite different. In training, the gradient of a training loss is with respect to weights/parameters θ of the perception component, and is used to find optimal parameters/weights for the perception component; in the present context, any weight/parameters θ of the perception component are fixed, and the gradient is with respect to the input x, with the objective of finding inputs that are “optimal” in the sense of meeting the attack objective.

A full white box attack would typically involve a combination of backpropagation and gradient descent (or ascent, depending on whichever arbitrary convention is adopted), in order to find some input x that optimizes the attack loss l(x). This would typically continue until the attack objective is fulfilled, e.g. by flipping the class label.

A viable strategy for the first stage is to perform full white box attacks on a perception component (or proxy component), and populate the data matrix D with successful attack vectors.

However, a full white box attack is not necessary in the present context. As noted, what is material in the present context is the direction of an attack, and an approximate direction is sufficient. Consider a gradient descent approach, in which ∇ₓl(x) is evaluated initially for some starting location, a step in the input space to the next input is taken in the direction of that gradient, and that process repeats until the algorithm converges. The size of the step decreases with the size of the gradient, and the changes in the gradient between steps become smaller. As the algorithm converges, smaller and smaller steps will be taken. In practice, the gradient taken at the starting location will be reasonably indicative of the direction of the final attack, with the later iterations serving to incrementally refine this initial estimate. Therefore, in a white box context, it is sufficient to simply populate D with gradients □ₓl(x) evaluated at different points x₀, x₁, x₂, . . . in the input space (in effect, considering only the first iteration of a full gradient descent). In this case

$$D = ( {∇}_{x} l ( x ) \vert {x}_{0} , {∇}_{x} l ( x ) {\vert}_{{x}_{1}} , {∇}_{x} l ( x ) {\vert}_{{x}_{2}} , … ) .$$

Preferably, those different points x₀, x₁, x₂ correspond to real images (as those points would then correspond to real starting points for an attack). However, the points x₀, x₁, x₂ can also be randomly chosen.

### Black Box Attack

A black box attack (BA) does not rely on computation of the gradients. Instead, it tries to estimate the gradient using input/output pairs. Existing BA methods can be used in the first phase. A new BA method is detailed below that can be applied in the first phase, as well as the second phase (but with different basis vectors).

In effect, a black box attack seeks to optimize an attack loss l(x) numerically. Such numerical method could be used to find successful attacks, or simply to identify promising attack direction (similar to above), and this may depend on the choice of numerical method. In the examples described below, numerical methods are considered which are able to reach an attack boundary extremely efficiently, and in this case, the data matrix D is populated with successful attack vectors.

The inputs x could be real or randomly generated.

Note that “black box” methods may be useful even when white box access is available. For example, certain neural networks might output scores that are capable of changing discontinuously as a function of the input to the network. As issue can arise with analytical methods in this case. To illustrate this, consider an extreme example, where the attack loss varies as a “staircase”-like function, jumping discontinuously between locally constant values. At the vast majority of points in the input space, the gradient is zero (because the attack loss is locally constant), which provides no insights into promising attack directions. What is needed in this case is a more global view of the attack loss.

A numerical, black box method can be applied in this context, and will effectively “smooth” the attack loss, to provide more useful gradient information than an analytical, white box method.

The staircase example is somewhat artificial. However, neural network can exhibit similar issues (albeit generally less extreme) in practice. For example, it is not uncommon for a “hack” to be applied to a neural network, in order to correct some specific issue (e.g. to correct some specific unwanted sensitivity to particular input structure), trying not to modify the rest of the network, and this can result in a degree of discontinuous behaviour.

Of course, another benefit of black box attacks is that they do not require white box access, and can be used when white box access is not available or is infeasible.

### Proxy Attack

A proxy attack means a white box attack or a black box attack applied to a “proxy” model. The proxy model could take the form of a model trained over the same perception classes as a “target” perception component to be attacked (and preferably reasonably similar data). If the training set of the target perception component is known, the same training set can be used to train the proxy model, although this is not essential, as evidence suggests that networks trained on the same or similar training objectives but on different training sets will nevertheless generalize in a similar manner.

### Data-Only Attack

In a data only attack, the data matrix D is simply populated with real inputs:

$$D = ( {x}_{0} , {x}_{1} , {x}_{2} , … ) .$$

As noted, this is based on the assumption that an SVD of the data matrix D will identify modes similar to those learned by the perception component in training on similar inputs. This is equivalent to a Principal Component Analysis of the real inputs x₀, x₁, x₂ . . . .

### Second Phase

As noted, the foundation of the second phase in the described approach is the Simple Black-box Attack (SimBA) of [14].

A simple sampling-and-decomposition process for supplying alternative values of an input basis matrix Q is illustrated, along with some simple alterations to enhance performance and conform to different threat models. The modified algorithm is referred to herein as “Mufasa”, and may be summarized in pseudo-code as follows:

```
Algorithm 1 Mufasa in Pseudocode
  1: procedure MUFASA(x, y, Q, ϵ)
  2:  δ = 0
  3:  $p = {p}_{h} ( y \vert x ) \underline{- {max}_{{y}^{′} \neq y} {p}_{h} ( {y}^{′} \vert x )}$
  4: while p_{y} = max_{y′} p_{y′} do
  5:  Pick in sequential order: q ∈ Q
  6:  for α ∈ {1, −1} do
  7:   ${p}^{′} = {p}_{h} ( y \vert x + \frac{δ + α q}{\underline{‖ δ + α q ‖}} \underline{ϵ} )$
  8:  if p′_{y} < p_{y} then
  9:  δ = δ + αq
10:  p = p′
11:  break
      $return \frac{δ}{\underline{‖ δ ‖}} \underline{ϵ}$
```

Notable differences with respect to the original SimBA algorithm are underlined in Algorithm 1. The differences include the substitution of a margin loss and the reinterpretation of the ϵ parameter as an l₂ norm bound which is fully utilised by each intermediate perturbation candidate. The basis matrix Q is expected to be supplied with its columns arranged in a preferred order, based on the offline analysis that produces it.

The essence of the modified approach is in the production of the basis matrix Q. In the l₂ setting, a straightforward method is to assemble a data matrix of adversarial attack perturbation vectors, take its singular value decomposition, and return the singular vectors ordered (as is standard) by decreasing singular values. That is, if the data matrix D is formed by stacking attack vectors as columns, then the SVD D=UΣV^{T} is computed in the first phase, and the matrix U is returned as the input Q into Algorithm 1.

The Mufasa approach differs from other methods in that it does not require dynamically maintaining or even forming a surrogate model (though that is an option, as discussed) and, in fact, involves no prior conditioning on the input point at all, at runtime. Rather, with the described approach, search directions are assigned a predefined order in the basis construction (phase 1), rather than choosing them randomly online. The Mufasa method also operates directly in that basis.

Mufasa incorporates gradient priors differently to [37] not least because the optimisation framework of [37] is bandits, and the gradient subspace of [37] is strongly conditioned on the point of evaluation, relying on diversification of the output of a single proxy net or a small ensemble through dropout/drop-layer.

In a machine learning (ML) context, a perception component may comprise one or more trained perception models for perceiving physical structure. For example, machine vision processing is frequently implemented using convolutional neural networks (CNNs). Such networks are typically trained on large numbers of training images which have been annotated with information that the neural network is required to learn (a form of supervised learning). At training time, the network is presented with thousands, or preferably hundreds of thousands, of such annotated images and learns for itself how features captured in the images themselves relate to annotations associated therewith. This is a form of visual structure detection applied to images. Each image is annotated in the sense of being associated with annotation data. The image serves as a perception input, and the associated annotation data provides a “ground truth” for the image. Perception components can also be applied to other perception modalities, such as lidar or radar inputs, or a combination of different perception modalities (e.g. two or more of image, lidar and radar). Such inputs may be captured using one or more perception sensors (e.g. image capture device(s), radar/lidar unit(s) etc.). Training and analysis of such components can also be performed using “synthetic” inputs, computed using one or more sensor models. Note all description herein relating to “real” inputs applies equally to synthetic inputs designed to approximate real inputs and which exhibit similar statistical properties (e.g. as generating using sensor model(s), such as camera, lidar or radar models, 3D modelling, possibly with techniques such as path tracking and the like to generate synthetic inputs). As well as images, CNNs and other forms of perception models/components can be architected to receive and process other forms of perception inputs, such as point clouds, voxel tensors, surface meshes etc., and to perceive structure in both 2D and 3D space. In the context of training generally, a perception input may be referred to as a “training example” or “training input”. By contrast, training examples captured for processing by a trained perception component at runtime may be referred to as “runtime inputs”. Annotation data associated with a training input provides a ground truth for that training input in that the annotation data encodes an intended perception output for that training input. In a supervised training process, parameters of a perception component are tuned systematically to minimize, to a defined extent, an overall measure of difference between the perception outputs generated by the perception component when applied to the training examples in a training set (the “actual” perception outputs) and the corresponding ground truths provided by the associated annotation data (the intended perception outputs). In this manner, the perception input “learns” from the training examples, and moreover is able to “generalize” that learning, in the sense of being able, one trained, to provide meaningful perception outputs for perception inputs it has not encountered during training.

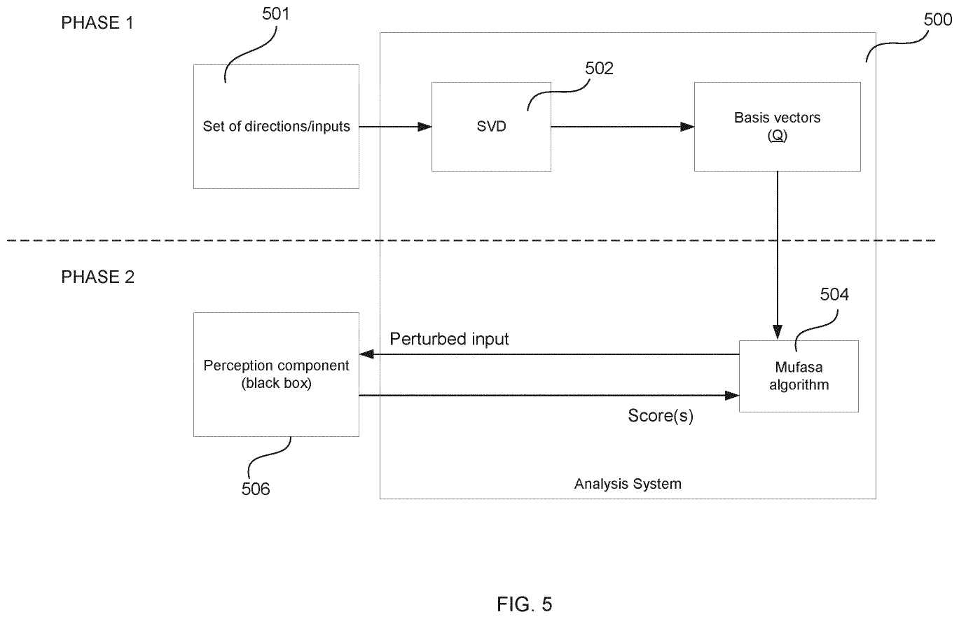

FIG. 5 shows a function block diagram of an analysis computer system 500 in which the two-phase approach may be implemented.

The computer system is shown to comprise a basis computation component 502 that receives, in Phase 1, an input set 501 of successful or promising attack direction, or a set of relevant inputs (data only approach), and applies a statistical analysis to the input set 501 in order to determine an ordered set of basis vectors Q. e.g. via SVD as described above.

The computer system 500 implements, in Phase 2, the Mufasa algorithm, labelled 504, using the ordered set of basis vectors Q (the order having been determined in the Phase 1).

Reference sign 506 denotes a perception component under attack in Phase 2. The Mufasa algorithm generates perturbed inputs as described above, which are passed to the perception component 506 as input, and receives corresponding score(s) computed by the perception component 506. The perception component 506 is shown outside of the analysis computer system 500 to emphasize the black box nature of the algorithm. However, in practice, it may or may not be implemented in an independent computer system (such as a remote server with a limited interface), depending on the context in which the analysis technique is used.

If the Mufasa algorithm 504 is able to find successful attacks (small perturbations that fool the perception component 506), those problems can be identified and mitigated through an appropriate modification to the perception component 506. For example, this could be part of a performance testing phase, to tune and improve the perception component before it is incorporated in a (physical) robotic system. Such testing is safety-critical in applications such as autonomous driving.

The analysis computer system 506 may take the form of a single computer or a distributed system of multiple computers.

Perception components are a cornerstone of many established and emerging technologies. For example, in the field of robotics, mobile robotic systems that can autonomously plan their paths in complex environments are becoming increasingly prevalent. An example of such a rapidly emerging technology is autonomous vehicles (AVs) that can navigate by themselves on urban roads. Such vehicles must not only perform complex manoeuvres among people and other vehicles, but they must often do so while guaranteeing stringent constraints on the probability of adverse events occurring, such as collision with these other agents in the environments. In order for an AV to plan safely, it is crucial that it is able to observe its environment accurately and reliably. This includes the need for accurate and reliable detection of real-world structure in the vicinity of the vehicle. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

References herein to components, functions, modules and the like, such as components 502, 504 in FIG. 5, denote functional components of a computer system, such as the analysis system 500, which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable though circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like).

### Results

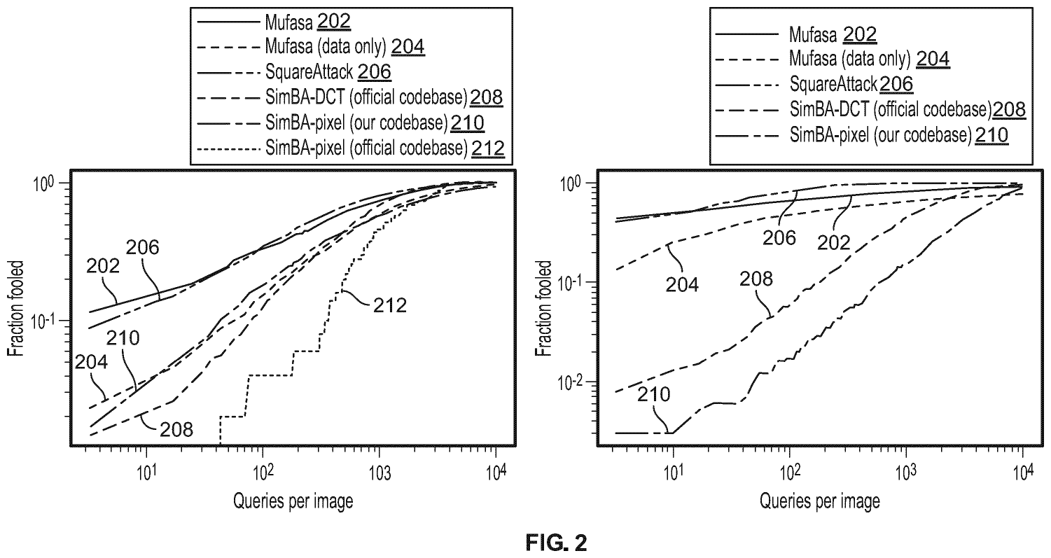

The described approach has been performance tested against state-of-the-art methods, with the results summarized in Table 1 and FIG. 2.

The “Square Attack” method is described in [2] (discussed below); “Bandits” is described in [37].

Reference [2] supplies a bespoke feature bank which essentially transfers domain knowledge, i.e. “features likely to fool”, both in the initialisation (vertical stripes) and the feature choice (homogeneous squares in the l_{∞} case, pairs of opposite-signed “decaying peaks” in the l₂).

As can be seen, the Mufasa approach is able to achieve results competitive with [2] on known benchmark datasets. Moreover, as noted above, Mufasa is able to achieve this level of performance without relying on complex or bespoke heuristics.

This stands in contrast to [2] which uses bespoke heuristics (and arguably complex heuristics, at least in the L2 case). In particular, [2] assumes certain properties of the networks being attacked in advance, i.e., a specific sort of vulnerability, incorporating domain-specific knowledge into their attack. [2] also uses bespoke initial patterns from which random perturbations are stared; it is inherently bespoke to attacking visual recognition systems (essentially classifiers/detectors), and even more specific to particular technologies like CNNs that have revealed themselves to be vulnerable to the specific choice of feature used in [2].

A key benefit of Mufasa is its additional flexibility with respect to the systems being attacked, and even with respect to the problem domain. As described, Mufasa doesn't inherently choose a feature set; rather, it receives as input a set of basis attack directions that has been computed in a systematic, data-driven manner via decomposition of a dataset; that dataset D can be readily tailored to the system (and problem domain) of interest, and the techniques used to distil and utilize the knowledge contained in D are generally applicable. In principle, a Mufasa variant could be applied to any system taking a multidimensional input and outputting a quantity on which a meaningful loss could be defined, assuming movements in that loss have a meaningful statistical correspondence with particular movements in that input space. By contrast, the features of [2] are hardcoded, and do not afford the same level of flexibility.

TABLE 1
Results of untargeted attacks on ImageNet with a limit of 10,000 queries. For
the l_{∞}-attack we set the norm bound ∈ = 0.05 and for the l₂-attack ∈ = 5.

| | | Failure rate (Median number of queries) | | | | | |
|---|---|---|---|---|---|---|---|
| Norm | Method | Inception-v3 | | ResNet-50 | | VGG16-bn | |
| l_{∞} | Bandits (from SA) | 3.4% | (218) | 1.4% | (136) | 2.0% | (36) |
| | SimBA-DCT (code) | 16.2% | (2319) | 3.1% | (1203) | 3.3% | (842) |
| | Square Attack (code) | 0.5% | (30) | 0.0% | (15) | 0.0% | (1) |
| | Mufasa [V] (ours) | 11% | (30) | 11.4% | (16) | — | (—) |
| | Mufasa [R] (ours) | 13% | (47) | 8.5% | (14) | 5.7% | (4) |
| l₂ | Bandits (from SA) | 9.8% | (660) | 6.8% | (392) | 10.2% | (196) |
| | SimBA-pixel (code) | 13.7% | (2118) | 0.0% | (1095) | 2.1% | (836) |
| | SimBA-DCT (code) | 6.0% | (993) | 1.3% | (582) | 2.7% | (479) |
| | SimBA-pixel (ours) | 23.75% | (2351) | 4.75% | (762) | 1.3% | (446) |
| | Square Attack (code) | 11.5% | (546) | 1.2% | (232) | 0.3% | (146) |
| | Mufasa [V] (ours) | 6.75% | (490) | 1.75% | (367) | — | (—) |
| | Mufasa [R] (ours) | 8.5% | (587) | 2.0% | (300) | 0.7% | (192) |

FIG. 2 shows Cumulative Distribution Functions for runs with bound on l₂ with ϵ=5.0 (left), and l_{∞} with ϵ=0:05 (right) for Mufasa 202, Mufasa (Data Only) 204, Square Attack [2] 206, SimBA with DCT basis 208 using the official codebase, and SimBA with pixel basis using the official code base (212) and also the modified Algorithm 1 above (210) but with Q substituted for the pixel basis.

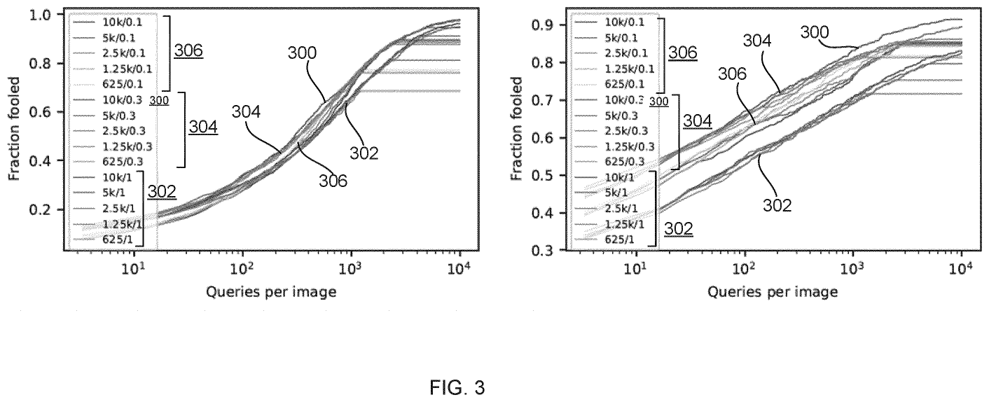

FIG. 3 shows CDFs for runs with bound on l₂ with ϵ=5.0 (left), and l_{∞} with ϵ=0.05 (right). Labels are in a/b format, where a is the number of components used and b is an applied downsampling factor. Results for b=1 (302), b=20.3 (304) and b=0.1 (306) are shown for a=[625, 1250, 2500, 5000, 10000], with the results for (a/b)=(10k/0.3) labelled 300.

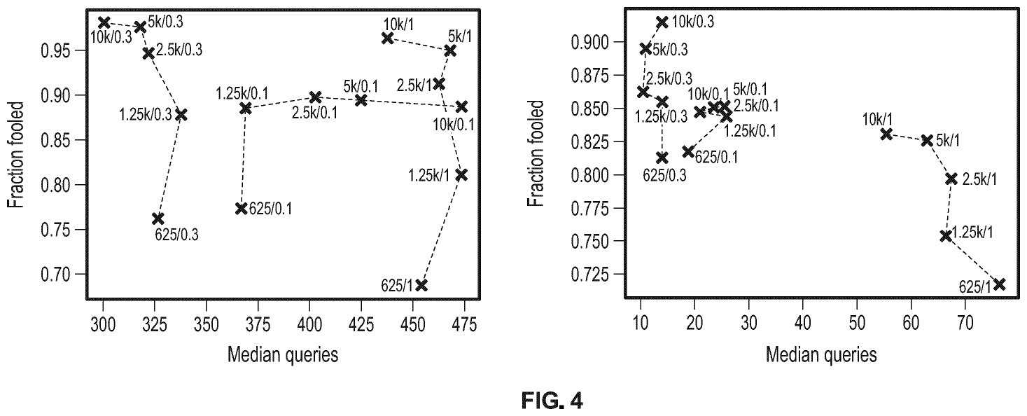

FIG. 4 shows scatterplots for runs with bound on l₂ with ϵ=5.0 (left), and l_{∞} with ϵ=0.05 (right). Labels are in a/b format, where a is the number of components used and b is an applied downsampling factor.

Herein, a computer-implemented method of generating black-box adversarial inputs to a perception component is provided, the method comprising: computing an adversarial input by applying a perturbation to an original input, the adversarial input satisfying an attack objective when inputted to the perception component; wherein the perturbation is determined by selectively combining component perturbations selected from a predetermined set of component perturbations; and wherein said inputs correspond to respective points in an input vector space, and the component perturbations encode principal attack directions in the input vector space for satisfying said attack objective, the principal attack directions having been determined by analysing: (i) a set of sample attack directions, or (ii) a set of input samples.

In embodiments, at least one of the sample attack directions may be a direction along which a successful attack has been observed.

Alternatively or additionally, at least one of the sample attack directions may be a promising attack direction.

The promising attack direction may be determined as a gradient of an attack loss function on the perception component or a proxy perception component.

The principal attack directions may be chosen by analysing the set of input samples, wherein input samples may be chosen that are similar to training inputs used to train the perception component under attack.

The analysis may be a decomposition of (i) or (ii). For example, the decomposition may be a singular value decomposition.

The method may comprise selectively modifying the perturbation vector, by selectively adding or subtracting component perturbations, until the successful attack condition is satisfied.

The component perturbations may be principal direction vectors of a principal direction matrix computed via the singular value decomposition.

The component perturbations may be assigned an order in performing the statistical analysis, and the perturbation vector may be selectively modified by applying the following steps, starting with the first component perturbation, until the successful attack condition is satisfied:
determining at least one modified perturbation, by adding or subtracting the component perturbation to/from the perturbation,
determining whether the modified perturbation satisfies a promising attack condition, and if so, repeating the steps for the next principal direction with the modified perturbation, and if not, discarding the modified perturbation, and repeating the steps for the steps for the next principal direction without modifying the perturbation.

The principal direction vectors may be ordered by decreasing singular value.

The perturbation may be selectively modified by applying the following steps:
determining a first modified perturbation, by doing one of: adding the component perturbation to the perturbation, and subtracting the component perturbation from the perturbation,
determining whether the first modified perturbation satisfies a promising attack condition, and if so repeating the steps for the next principal direction with the first modified perturbation,
if not, discarding the first modified perturbation, and determining a second modified perturbation, by doing the other one of: adding the component perturbation to the perturbation, and subtracting the component perturbation from the perturbation,
determining whether the second modified perturbation satisfies the promising attack condition, and if so repeating the steps for the next principal direction with the second modified perturbation,
if not, discarding the second modified perturbation, and repeating the steps for the next principal direction without modifying the perturbation.

The following operations may be performed to determine whether a modified perturbation satisfies the promising attack condition:
applying the modified perturbation to the original input vector, to compute a perturbed input vector,
providing the perturbed input vector to the perception component, to obtain at least one numerical output value,
in the case of the first component perturbation, comparing the numerical output value with a corresponding numerical output value obtained for the original input, in order to determine whether the promising attack condition is satisfied,
in the case of each subsequent component perturbation, comparing the numerical output value with the numerical output value obtained for the previous component perturbation, in order to determine whether the promising attack condition is satisfied.

The comparison may be performed to determine whether an attack loss has been increased or decreased relative to the original inputs, where the attack loss encodes the attack objective.

Each numerical output value may be a confidence score, and the promising attack condition may be satisfied if the numerical output value indicates decreased confidence of the perception component.

The confidence score may pertain to a known class to which the original input belongs, and the promising attack condition may be satisfied if the numerical output value indicates decreased classification confidence with respect to the known class.

Alternatively, the confidence score may pertain to a specific class other than a known class to which the original input belongs, and the promising attack condition may satisfied if the numerical output value indicates increased classification confidence with respect to the specific other class.

The confidence score may be a confidence score for object detection output.

The method may comprise, based on the adversarial input, identifying and mitigating a problem with the perception component.

The perception component may be modified so that the adversarial input no longer satisfies the attack objective.

Each input may comprise image data, liar data or radar data.

The perception component may be for use in a robotic system for perceiving physical structure in an environment in which the robot system is operating.

The method may comprise incorporating the modified perception component in a robotic system.

Further aspects herein provide a computer system comprising one or more computers configured to implement any method or system functionality described herein, and transitory or non-transitory media embodying executable program instructions configured to program a computer system to implement any such method.

### REFERENCES

Each of the following is incorporated herein by reference in its entirety:
[1] A. Al-Dujaili and U.-M. O'Reilly. Sign bits are all you need for black-box attacks. In International Conference on Learning Representations, 2019.
[2] M. Andriushchenko, F. Croce, N. Flammarion, and M. Hein. Square attack: a query-efficient black-box adversarial attack via random search. In European Conference on Computer Vision, pages 484-501. Springer, 2020.
[3] A. N. Bhagoji, W. He, B. Li, and D. Song. Practical black-box attacks on deep neural networks using efficient query mechanisms. In Proceedings of the European Conference on Computer Vision (ECCV), pages 154-169, 2018.
[4] W. Brendel and M. Bethge. Approximating cnns with bag-of-local-features models works surprisingly well on imagenet. In International Conference on Learning Representations, 2018.
[5] T. Brunner, F. Diehl, M. T. Le, and A. Knoll. Guessing smart: Biased sampling for efficient black-box adversarial attacks. In Proceedings of the IEEE/CVF International Conference on Computer Vision, pages 4958-4966, 2019.
[6] N. Carlini and D. Wagner. Towards evaluating the robustness of neural networks. In 2017 IEEE symposium on security and privacy (sp), pages 39-57. IEEE, 2017.
[7] P.-Y. Chen, H. Zhang, Y. Sharma, J. Yi, and C.-J. Hsieh. Zoo: Zeroth order optimization based black-box attacks to deep neural networks without training substitute models. In Proceedings of the 10th ACM workshop on artificial intelligence and security, pages 15-26, 2017.
[8] M. Cheng, S. Singh, P. H. Chen, P.-Y. Chen, S. Liu, and C.-J. Hsieh. Sign-opt: A query-efficient hard-label adversarial attack. In International Conference on Learning Representations, 2019.
[9] S. Cheng, Y. Dong, T. Pang, H. Su, and J. Zhu. Improving black-box adversarial attacks with a transfer-based prior. Advances in Neural Information Processing Systems, 32:10934-10944, 2019.
[10] H. M. Dolatabadi, S. Erfani, and C. Leckie. Advflow: Inconspicuous black-box adversarial attacks using normalizing flows. arXiv preprint arXiv:2007.07435, 2020.
[11] A. Fawzi, S.-M. Moosavi-Dezfooli, P. Frossard, and S. Soatto. Empirical study of the topology and geometry of deep networks. In Proceedings of the IEEE Conference on Computer Vision and Pattern Recognition, pages 3762-3770, 2018.
[12] I. J. Goodfellow, J. Shlens, and C. Szegedy. Explaining and harnessing adversarial examples. arXiv preprint arXiv:1412.6572, 2014.
[13] C. Guo, J. S. Frank, and K. Q. Weinberger. Low frequency adversarial perturbation. In Uncertainty in Artificial Intelligence, pages 1127-1137. PMLR, 2020.
[14] C. Guo, J. Gardner, Y. You, A. G. Wilson, and K. Weinberger. Simple black-box adversarial attacks. In International Conference on Machine Learning, pages 2484-2493. PMLR, 2019.
[15] A. Ilyas, L. Engstrom, A. Athalye, and J. Lin. Black-box adversarial attacks with limited queries and information. In International Conference on Machine Learning, pages 2137-2146. PMLR, 2018.
[16] A. Ilyas, L. Engstrom, and A. Madry. Prior convictions: Black-box adversarial attacks with bandits and priors. In International Conference on Learning Representations, number 2019, 2019.
[17] A. Ilyas, S. Santurkar, L. Engstrom, B. Tran, and A. Madry. Adversarial examples are not bugs, they are features. Advances in neural information processing systems, 32, 2019.
[18] S. Jetley, N. A. Lord, and P. H. Torr. With friends like these, who needs adversaries? In Proceedings of the 32nd International Conference on Neural Information Processing Systems, pages 10772-10782, 2018.
[19] Y. Li, L. Li, L. Wang, T. Zhang, and B. Gong. Nattack: Learning the distributions of adversarial examples for an improved black-box attack on deep neural networks. In International Conference on Machine Learning, pages 3866-3876. PMLR, 2019.
[20] X. Liu, T. Hu, K. Ding, Y. Bai, W. Niu, and J. Lu. A black-box attack on neural networks based on swarm evolutionary algorithm. In Australasian Conference on Information Security and Privacy, pages 268-284. Springer, 2020.
[21] Y. Liu, X. Chen, C. Liu, and D. Song. Delving into transferable adversarial examples and black-box attacks. arXiv preprint arXiv:1611.02770, 2016.
[22] A. Madry, A. Makelov, L. Schmidt, D. Tsipras, and A. Vladu. Towards deep learning models resistant to adversarial attacks. In International Conference on Learning Representations, 2018.
[23] S. Moon, G. An, and H. O. Song. Parsimonious black-box adversarial attacks via efficient combinatorial optimization. In International Conference on Machine Learning, pages 4636-4645. PMLR, 2019.
[24] S.-M. Moosavi-Dezfooli, A. Fawzi, O. Fawzi, and P. Frossard. Universal adversarial perturbations. In Proceedings of the IEEE conference on computer vision and pattern recognition, pages 1765-1773, 2017.
[25] S.-M. Moosavi-Dezfooli, A. Fawzi, O. Fawzi, P. Frossard, and S. Soatto. Robustness of classifiers to universal perturbations: A geometric perspective. In International Conference on Learning Representations, 2018.
[26] S.-M. Moosavi-Dezfooli, A. Fawzi, and P. Frossard. Deepfool: a simple and accurate method to fool deep neural networks. In Proceedings of the IEEE conference on computer vision and pattern recognition, pages 2574-2582, 2016.
[27] N. Papernot, P. McDaniel, I. Goodfellow, S. Jha, Z. B. Celik, and A. Swami. Practical black-box attacks against machine learning. In Proceedings of the 2017 ACM on Asia conference on computer and communications security, pages 506-519, 2017.
[28] A. K. Sahu, S. N. Shukla, and J. Z. Kolter. Gaussian mrf covariance modeling for efficient black-box adversarial attacks. arXiv preprint arXiv:2010.04205, 2020.
[29] S. Sarkar, A. Bansal, U. Mahbub, and R. Chellappa. Upset and angri: Breaking high performance image classifiers. arXiv preprint arXiv:1707.01159, 2017.
[30] Y. Shi, S. Wang, and Y. Han. Curls & whey: Boosting black-box adversarial attacks. In Proceedings of the IEEE/CVF Conference on Computer Vision and Pattern Recognition, pages 6519-6527, 2019.
[31] K. Simonyan, A. Vedaldi, and A. Zisserman. Deep inside convolutional networks: Visualising image classification models and saliency maps. arXiv preprint arXiv:1312.6034, 2013.
[32] Y. Tashiro, Y. Song, and S. Ermon. Diversity can be transferred: Output diversification for white-and black-box attacks. Advances in Neural Information Processing Systems, 33, 2020.
[33] C.-C. Tu, P. Ting, P.-Y. Chen, S. Liu, H. Zhang, J. Yi, C.-J. Hsieh, and S.-M. Cheng. Autozoom: Autoencoder-based zeroth order optimization method for attacking black-box neural networks. In Proceedings of the AAAI Conference on Artificial Intelligence, volume 33, pages 742-749, 2019.
[34] J. Wang, Z. Yin, J. Tang, J. Jiang, and B. Luo. Pica: A pixel correlation-based attentional black-box adversarial attack. arXiv preprint arXiv:2101.07538, 2021.
[35] D. Willmott, A. K. Sahu, F. Sheikholeslami, F. Condessa, and Z. Kolter. You only query once: Effective black box adversarial attacks with minimal repeated queries. arXiv preprint arXiv:2102.00029, 2021.
[36] Z. Yan, Y. Guo, J. Liang, and C. Zhang. Policy-driven attack: Learning to query for hard-label black-box adversarial examples.
[37] Z. Yan, Y. Guo, and C. Zhang. Subspace attack: Exploiting promising subspaces for query-efficient black-box attacks. arXiv preprint arXiv:1906.04392, 2019.
[38] J. Yang, Y. Jiang, X. Huang, B. Ni, and C. Zhao. Learning black-box attackers with transferable priors and query feedback. Advances in Neural Information Processing Systems, 33, 2020.
[39] B. Zhou, A. Khosla, A. Lapedriza, A. Oliva, and A. Torralba. Learning deep features for discriminative localization. In Proceedings of the IEEE conference on computer vision and pattern recognition, pages 2921-2929, 2016.

1. A computer-implemented method of generating black-box adversarial inputs to a perception component, the method comprising:
computing an adversarial input by applying a perturbation to an original input, the adversarial input satisfying an attack objective when inputted to the perception component;
wherein the perturbation is determined by selectively combining component perturbations selected from a predetermined set of component perturbations; and
wherein said inputs correspond to respective points in an input vector space, and the component perturbations encode principal attack directions in the input vector space for satisfying said attack objective, the principal attack directions having been determined by analysing: (i) a set of sample attack directions, or (ii) a set of input samples.

2. The method of claim 1, wherein at least one of the sample attack directions is a direction along which a successful attack has been observed, or a promising attack direction.

3. (canceled)

4. The method of claim 2, wherein the promising attack direction is determined as a gradient of an attack loss function on the perception component or a proxy perception component.

5. The method of claim 1, wherein the principal attack directions are chosen by analysing the set of input samples, wherein input samples are chosen that are similar to training inputs used to train the perception component under attack.

6. The method of claim 1, wherein said analysis is a singular value decomposition of (i) or (ii) or other decomposition of (i) or (ii).

7. (canceled)

8. The method of claim 1, comprising:
selectively modifying the perturbation, by selectively adding or subtracting component perturbations, until the successful attack condition is satisfied.

9. The method of claim 6, comprising:
selectively modifying the perturbation, by selectively adding or subtracting component perturbations, until the successful attack condition is satisfied; and
wherein the component perturbations are principal direction vectors of a principal direction matrix computed via the singular value decomposition.

10. The method of claim 6, wherein the component perturbations are assigned an order in performing the statistical analysis, and the perturbation is selectively modified by applying the following steps, starting with the first component perturbation, until the successful attack condition is satisfied:
determining at least one modified perturbation, by adding or subtracting the component perturbation to/from the perturbation,
determining whether the modified perturbation satisfies a promising attack condition, and if so, repeating the steps for the next principal direction with the modified perturbation, and if not, discarding the modified perturbation, and repeating the steps for the steps for the next principal direction without modifying the perturbation.

11. The method of claim 10, wherein said analysis is a singular value decomposition of (i) or (ii), the method comprising:
selectively modifying the perturbation, by selectively adding or subtracting component perturbations, until the successful attack condition is satisfied;
wherein the component perturbations are principal direction vectors of a principal direction matrix computed via the singular value decomposition; and
wherein the principal direction vectors are ordered by decreasing singular value.

12. The method of claim 10, wherein the perturbation is selectively modified by applying the following steps:
determining a first modified perturbation, by doing one of: adding the component perturbation to the perturbation, and subtracting the component perturbation from the perturbation,
determining whether the first modified perturbation satisfies a promising attack condition, and if so repeating the steps for the next principal direction with the first modified perturbation,
if not, discarding the first modified perturbation, and determining a second modified perturbation, by doing the other one of: adding the component perturbation to the perturbation, and subtracting the component perturbation from the perturbation,
determining whether the second modified perturbation satisfies the promising attack condition, and if so repeating the steps for the next principal direction with the second modified perturbation,
if not, discarding the second modified perturbation, and repeating the steps for the next principal direction without modifying the perturbation.

13. The method of any of claims 10, wherein the following operations are performed to determine whether a modified perturbation satisfies the promising attack condition:
applying the modified perturbation to the original input vector, to compute a perturbed input vector,
providing the perturbed input vector to the perception component, to obtain at least one numerical output value,
in the case of the first component perturbation, comparing the numerical output value with a corresponding numerical output value obtained for the original input, in order to determine whether the promising attack condition is satisfied,
in the case of each subsequent component perturbation, comparing the numerical output value with the numerical output value obtained for the previous component perturbation, in order to determine whether the promising attack condition is satisfied.

14. The method of claim 13,
wherein the comparison is performed to determine whether an attack loss has been increased or decreased relative to the original inputs, where the attack loss encodes the attack objective.

15. The method of claim 14, wherein each numerical output value is a confidence score, and the promising attack condition is satisfied if the numerical output value indicates decreased confidence of the perception component, wherein the confidence score pertains to:
a known class to which the original input belongs, and the promising attack condition is satisfied if the numerical output value indicates decreased classification confidence with respect to the known class, or
a specific class other than a known class to which the original input belongs, and the promising attack condition is satisfied if the numerical output value indicates increased classification confidence with respect to the specific other class.

16.-18. (canceled)

19. The method of claim 1, comprising:
based on the adversarial input, identifying and mitigating a problem with the perception component.

20. The method of claim 1, comprising modifying the perception component so that the adversarial input no longer satisfies the attack objective.

21. The method of claim 1, wherein each input comprises image data, liar data or radar data.

22. (canceled)

23. The method of claim 20, comprising incorporating the modified perception component in a robotic system.

24. The method of claim 1, wherein the statistical analysis assigns a relative order to the component perturbations, reflecting relative dominance of the principal attack directions, and the component perturbations are selectively combined in the assigned relative order.

25. A computer system comprising:
at least one memory configured to store computer-readable instructions;
at least one hardware processor coupled to the at least one memory and configured to execute the computer-readable instructions, which upon execution cause the at least one hardware processor to generate black-box adversarial inputs to a perception component, by:
computing an adversarial input by applying a perturbation to an original input, the adversarial input satisfying an attack objective when inputted to the perception component;
determining the perturbation by selectively combining component perturbations selected from a predetermined set of component perturbations, wherein said inputs correspond to respective points in an input vector space, and the component perturbations encode principal attack directions in the input vector space for satisfying said attack objective; and
determining the principal attack directions by analysing: (i) a set of sample attack directions, or (ii) a set of input samples.

26. (canceled)

27. A non-transitory medium embodying computer-readable instructions configured, when executed on one or more hardware processors, to generate black-box adversarial inputs to a perception component, by:
computing an adversarial input by applying a perturbation to an original input, the adversarial input satisfying an attack objective when inputted to the perception component;
determining the perturbation by selectively combining component perturbations selected from a predetermined set of component perturbations, wherein said inputs correspond to respective points in an input vector space, and the component perturbations encode principal attack directions in the input vector space for satisfying said attack objective; and
determining the principal attack directions by analysing: (i) a set of sample attack directions, or (ii) a set of input samples.
